(19) United States
(12) Patent Application Publication
(10) Pub. No.: US 2014/0006133 A1
(43) Pub. Date: Jan. 2, 2014

(54) SOFTWARE AND METHODS TO GOVERN THE ISSUANCE, USE AND REDEMPTION OF CODES

(71) Applicant: Matthew Scott Peterson, Highland Park, IL (US)

(72) Inventor: Matthew Scott Peterson, Highland Park, IL (US)

(21) Appl. No.: 13/539,443

(22) Filed: Jun. 30, 2012

(51) Int. Cl. G06Q 30/02

(52) U.S. Cl. 705/14.26

(57) ABSTRACT

A system allows a company to configure custom post purchase marketing campaigns to offer to customers. Customers can receive a code via email, postcard, receipt, onpack, or the like, distributed by the company to the customer after a purchase. The customer can then follow the redemption instructions and access a web site, according to an aspect of the present invention, to complete the claim for benefit in the form of a reward or warranty. By establishing a single point of entry, the customer benefits from easy access to the status of their claim and offers value. The business offering the reward is insured that the rules governing the offer are followed on all claims. The system establishes the rules that govern post purchase reward redemption codes, supports the redemption ecosystem, creates, distributes, validates, and fulfills based on eligible codes assigned to clients.

### BACKGROUND OF THE INVENTION

The present invention relates to applications and methods related to post purchase rewards, warranties, and the like and more particularly, to software and methods to govern the issuance, use and redemption of post purchase rewards, codes, warranties, and the like.

A business that wants to offer codes post purchase would need to build a system from scratch, in-house. This can be time consuming, expensive and would require particular specialized know-how.

Current post purchase promotion code systems are either used as a sweepstakes or are configured for in-house use, such as mycokerewards, for example. There is currently no universal use solution where businesses, small and large, could develop and implement a post purchase promotion.

As can be seen, there is a need for software and methods to provide a secure system to issue, use and redeem post promotion codes.

### SUMMARY OF THE INVENTION

In one aspect of the present invention, a computer-implemented method, written as a programmable code, stored on a digital readable medium, and adapted to provide a system for issuing, using and redeeming codes, the method comprises defining program rules for issuing, using and redeeming codes; distributing codes to consumers post purchase; validating the code; and providing a consumer who presents a validated code with a choice of reward options.

In another aspect of the present invention, a system for issuing, using and redeeming awards comprises an application server configured to obtain code issuance and redemption policies from a company; an internet web site configured to permit consumers to enter codes provided to consumers post purchase for validation; and a server adapted to provide the consumer with at least one of a redemption reward and a warranty.

These and other features, aspects and advantages of the present invention will become better understood with reference to the following drawings, description and claims.

### BRIEF DESCRIPTION OF THE DRAWINGS

FIG. 1 is a schematic diagram showing an exemplary architecture of the system of the present invention; and

FIG. 2 is a flow chart showing the logical flow of the system of the present invention.

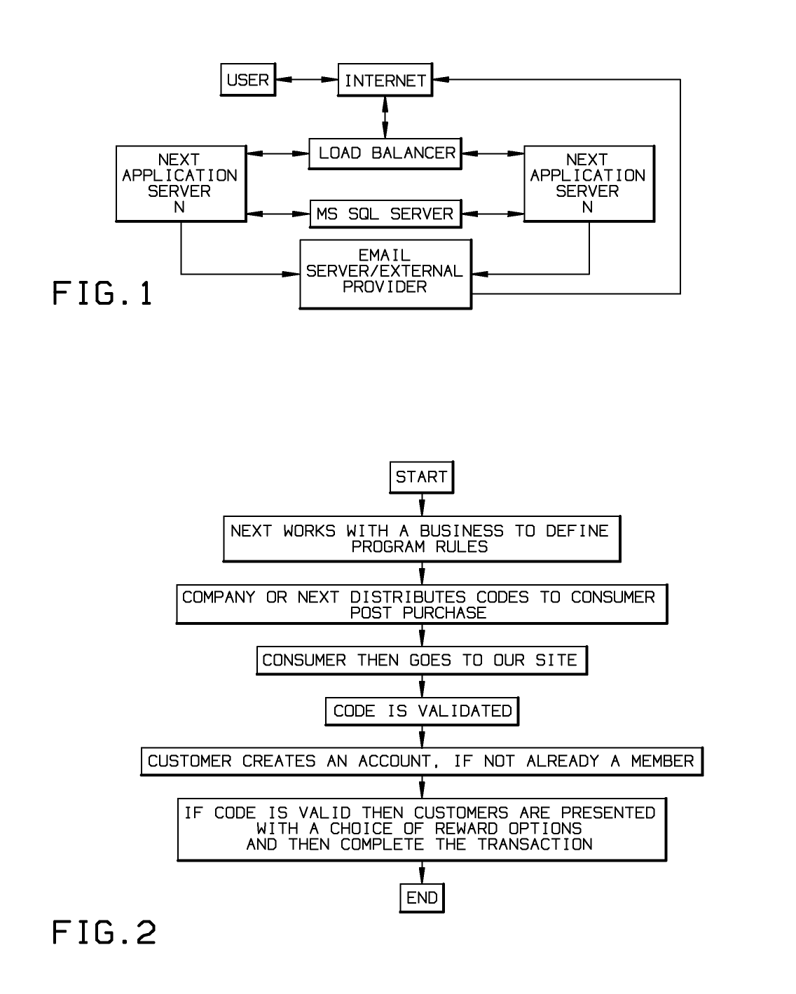

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system that allows a company to configure custom post purchase marketing campaigns to offer to customers. Customers can receive a code via email, postcard, receipt, onpack, or the like, distributed by the company to the customer after a purchase. The customer can then follow the redemption instructions and access a web site, according to an aspect of the present invention, to complete the claim for benefit in the form of a reward or warranty. By establishing a single point of entry, the customer benefits from easy access to the status of their claim and offers value. The business offering the reward is insured that the rules governing the offer are followed on all claims. The system establishes the rules that govern post purchase reward redemption codes, supports the redemption ecosystem, creates, distributes, validates, and fulfills based on eligible codes assigned to clients. Clients distribute codes to customers and customers redeem codes at a web site.

The system of the present invention can include enhanced security and validation features, including databases from outside sources. Reward choice can be established by clients to conform to needs, including warranty registration and banked dollars, for example. The system of the present invention can integrate into social media and mobile phone applications.

The system of the present invention includes software that may be written in any one or more programming languages. In some embodiments, the software may be designed to operate on a computer system, having a central processing unit, memory and other typical computer components. In some embodiments, the software may reside on a server and operate on various computers or computer terminals. In some embodiments, the software may reside at least partially on a server or cloud-based system or on an internet-based system, where data may be interchanged with the software of the present invention. Security measures may be included with the software, such as data encryption, to permit the secure exchange of information with the software of the present invention. The code can govern all the interactions described herewithin, including, but not limited to external data exchange, account invoicing, fulfillment, exporting files and reporting.

The software of the present invention may include computer code, disposed on a computer readable medium, adapted to perform the various functions as described herewithin.

A system of the present invention can be used both by clients (businesses looking to establish a custom marketing campaign to collect and validate information required to receive a benefit) and customers (to validate and redeem post purchase promotion codes). A client can use the invention to design a custom marketing campaign. The client can use the system to control all aspects of the marketing program—timing, eligibility, reward selection, communication, and the like. A client can set up a program within an hour and begin using the system. Once established, the client has confidence that all transactions are evaluated consistently, data is collected and rewards are distributed, saving time, money and improving marketing knowledge.

The system of the present invention can be extended to mobile devices, QR and/or bar code technology and can be used in social media platforms. Where an individual or business may want to give a variable gift to a group of friends of clients, they can use the system of the present invention to make giving rewards/gifts/benefits more easily and in a secure environment.

Referring to the Figures, to use the system of the present invention, a company can contract with the system provider and provide the number of codes, value of the codes and approve a reward selection. The company can provide artwork and terms and conditions to the system provider. The company can direct the system provider on all code validation rules and code distribution methods. The company can determine the start date and end date of the program, along with the expiration dates of the codes. If there is any social media integration, the company can provide links to various social media products. Once the above set-up steps are complete, the program can be launched.

When the customer makes a purchase or goods or services at a participating company, a code can be issued to the purchasing customer. The customer can sign into the system provider's web site to validate the code, collect the required data, validate additional data elements, and provide the customer with terms and conditions. The customer can select from a choice of eligible rewards/benefits, confirm their selection and an email confirmation can be sent to the customer.

The customer can be invited to join the company's social media product, if desired. The customer can redeem multiple codes, check history/status of prior submitted codes, and update their contact information.

Upon successful redemption of a code, the system adds the code to the master database for reporting. A file can be produced and any selection is fulfilled based on contracted terms. Additional emails, based on the fulfillment process, can be sent to the customer and the customer can return to the online system at any time to check on their account status and history.

For warranty customers, they can download online user manuals, access information about their product, make a warranty claim, check warranty coverage status, and the like.

It should be understood, of course, that the foregoing relates to exemplary embodiments of the invention and that modifications may be made without departing from the spirit and scope of the invention as set forth in the following claims.

What is claimed is:

1. A computer-implemented method, written as a programmable code, stored on a digital readable medium, and adapted to provide a system for issuing, using and redeeming codes, the method comprising:
defining program rules for issuing, using and redeeming codes;
distributing codes to consumers post purchase;
validating the code; and
providing a consumer who presents a validated code with a choice of reward options.

2. The method of claim 1, wherein the step of defining program rules includes the company providing a number of codes, activation of codes, a value for codes and a reward selection.

3. The method of claim 1, wherein the validating of the code is achieved through a consumer-accessed web site.

4. The method of claim 1, further comprising providing at least one or a reward or a warranty upon redemption of a validated code.

5. The method of claim 1, further comprising creating an account for the consumer on a code validation web site.

6. The method of claim 1, further comprising emailing a confirmation to the consumer once a reward option is chosen.

7. A system for issuing, using and redeeming awards, comprising:
an application server configured to obtain code issuance and redemption policies from a company;
an internet web site configured to permit consumers to enter codes provided to consumers post purchase for validation; and
a server adapted to provide the consumer with at least one of a redemption reward and a warranty.

8. The system of claim 7, wherein the internet web site allows the consumer to establish an account to access redemption history and status of prior submitted codes.

9. The system of claim 7, wherein the code issuance policies include a number of codes, a value of codes, and reward selections.

10. The system of claim 7, further comprising an email server for delivering a confirmation email to the consumer upon redemption of the code.
